(19) United States
(12) Patent Application Publication
(10) Pub. No.: US 2023/0192067 A1
(43) Pub. Date: Jun. 22, 2023

(54) MOTION PLANNER CONSTRAINT GENERATION BASED ON ROAD SURFACE HAZARDS

(71) Applicant: Motional AD LLC, Boston, MA (US)

(72) Inventors: Puneet Singhal, Pittsburgh, PA (US); Bence Cserna, East Boston, MA (US)

(21) Appl. No.: 17/534,223

(22) Filed: Nov. 23, 2021

(51) Int. Cl. B60W 30/02; G06K 9/00; G06T 7/70; G06T 7/40; G06T 7/62; G05D 1/02

(52) U.S. Cl. CPC B60W 30/02; G05D 1/027; G05D 1/0214; G05D 1/0223; G05D 1/0246; G05D 1/0255; G06K 9/00805; G06T 7/40; G06T 7/62; G06T 7/70; B60W 2420/42; B60W 2420/54; B60W 2520/40; B60W 2552/15; B60W 2552/40; B60W 2555/20; B60W 2710/207; B60W 2720/10; B60W 2720/12; B60W 2720/106; B60W 2720/125; B60W 2754/20; B60W 2754/30; G06T 2207/30261

(57) ABSTRACT

Provided are methods for motion planner constraint generation based on road surface hazards, which can include receiving information about an object, identifying the object as a particular road hazard, generating one or more motion constraints based on the road hazard, and controlling a vehicle based on the motion constraints. Systems and computer program products are also provided.

### BACKGROUND

Hazards often occur on road surfaces and can affect a condition of the road surface. Hazards include, but are not limited to, animals, rough roads, gravel, bumpy edges, uneven expansion joints, slick surfaces, standing water, debris, snow, ice, or objects that have fallen from a construction site or another vehicle. Hazards impact the operation of a vehicle. For example, a vehicle can change its path or speed to in response to a hazard.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIGS. 5A and 5B are diagrams of an implementation of a process for motion planner constraint generation based on road surface hazards;

FIG. 6 illustrates an example scenario of a vehicle identifying a road hazard;

FIG. 7 illustrates an example scenario of a sensor generating information of a road hazard based on received light;

FIG. 8 illustrates an example scenario of two always-on sensors generating information of a road hazard based on received light;

FIG. 9 illustrates an example scenario of an emitter producing light and an on-demand sensor generating information of a road hazard based on received light;

FIG. 10 illustrates a first example of motion constraints associated with a particular road hazard and a vehicle being controlled based on the motion constraints;

FIG. 11 illustrates a second example of motion constraints associated with a particular road hazard and a vehicle being controlled based on the motion constraints;

FIGS. 12A-12C illustrate a temporal variation of road hazards;

FIG. 13 illustrates a vehicle storing road hazard information in memory;

FIG. 14 is a flowchart of a process for motion planner constraint generation based on road surface hazards; and

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement steps for identifying road hazards (e.g., debris, ice, water, oil, sand, or snow) that are present on a road surface that a vehicle (e.g., an autonomous vehicle) is traveling along. The vehicle is controlled based on a presence of the road hazard (e.g., via steering and/or braking controls).

In general, an autonomous vehicle compute (also referred to as an “AV stack”) accounts for the identified road hazard by determining motion constraints that are transmitted to a motion planner of the vehicle. The motion planner, in turn, plans a trajectory of the vehicle subject to these motion constraints and controls the vehicle to follow the trajectory. In some examples, the AV stack accounts for the identified road hazard by slowing down. In other examples, the vehicle accounts for the identified road hazard by navigating around the road hazard.

By virtue of the implementation of systems, methods, and computer program products described herein, techniques for motion planner constraint generation based on road surface hazards provide one or more of the following advantages.

In some examples, this technology enables safer vehicle travel. For example, an autonomous or partially autonomous vehicle that identifies an upcoming road hazard as soon as possible has more time to react to the road hazard. For example, a vehicle that can identify an ice patch on the road means that the vehicle can determine to avoid the ice patch by steering around the ice patch. In this way, identifying the road hazard and determining the suitable motion constraints as soon as possible provides a safer vehicle ride compared to vehicles without such technology because otherwise the vehicle would continue driving as normal through the road hazard potentially resulting in an accident. In this way, passengers within the vehicle, other vehicles, pedestrians, and animals within the environment are all safer with this technology.

Another way this technology enables safer vehicle travel is by determining motion constraints based on a particular road hazard. For example, when the technology identifies the road hazard as a slippery condition (e.g., sand, ice, oil, etc.) and also determines that avoiding the road hazard is not feasible (e.g. blocked lanes of travel, the road hazard covers the entire width of the road surface, etc.), this technology applies a motion constraint to the vehicle’s trajectory to avoid sudden vehicle trajectory changes (e.g., sudden changes to the direction of travel of the vehicle, sudden changes to the acceleration of the vehicle, etc.). Avoiding sudden vehicle trajectory changes reduces the likelihood that the vehicle will lose control as it travels through the road hazard.

In some examples, this technology is energy efficient because it uses both always-on sensors (e.g., sensors that would be used for normal driving [e.g., RADAR, LIDAR, cameras, etc.] and on-demand sensors (e.g., sensors that are used only when the technology determines that a road hazard is likely ahead [e.g., above a threshold] [e.g., cameras with a long-range zoom lens, etc.]).

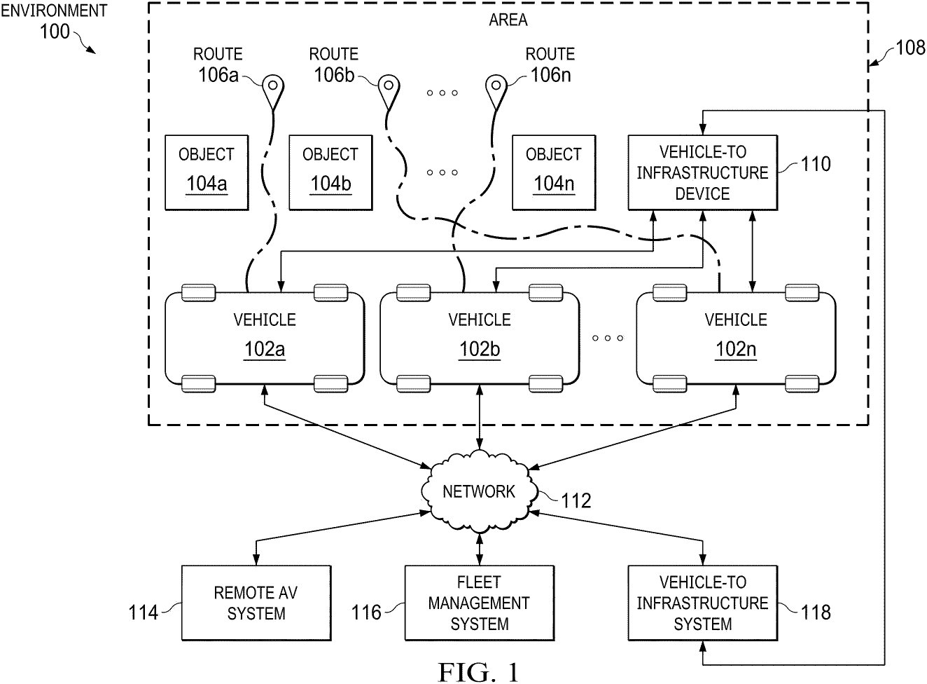

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

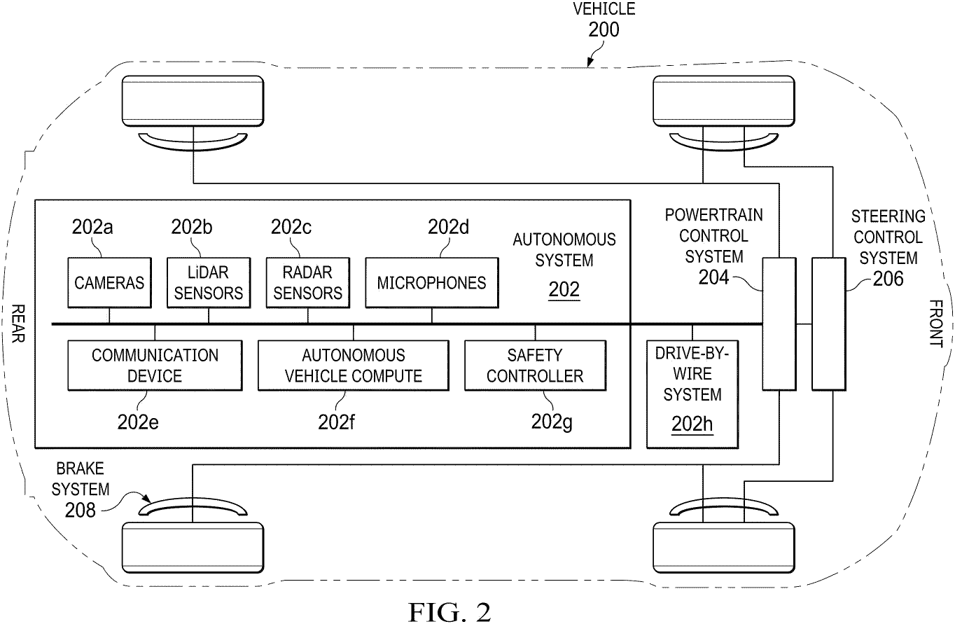

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber opticbased network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International’s standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

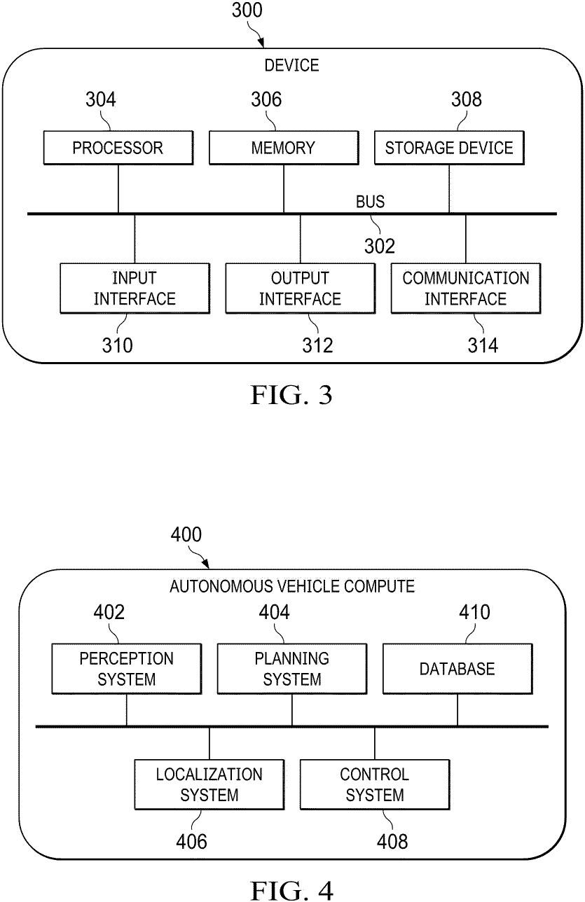

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or one or more devices of network 112 (e.g., one or more devices of a system of network 112). In some embodiments, one or more devices of vehicles 102 (e.g., one or more devices of a system of vehicles 102) and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “system” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a system is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406, and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

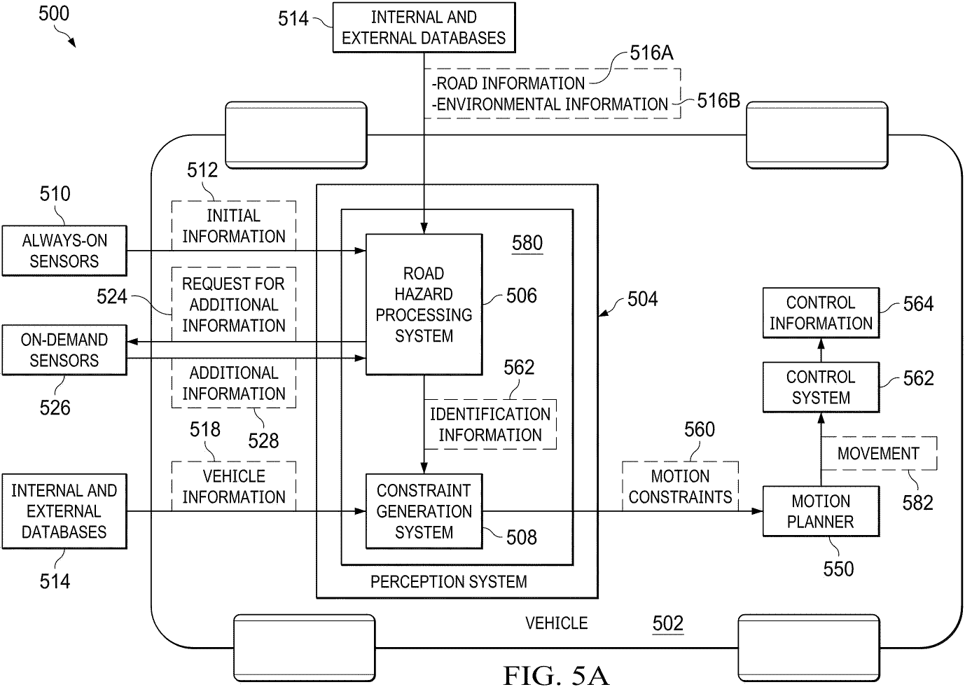

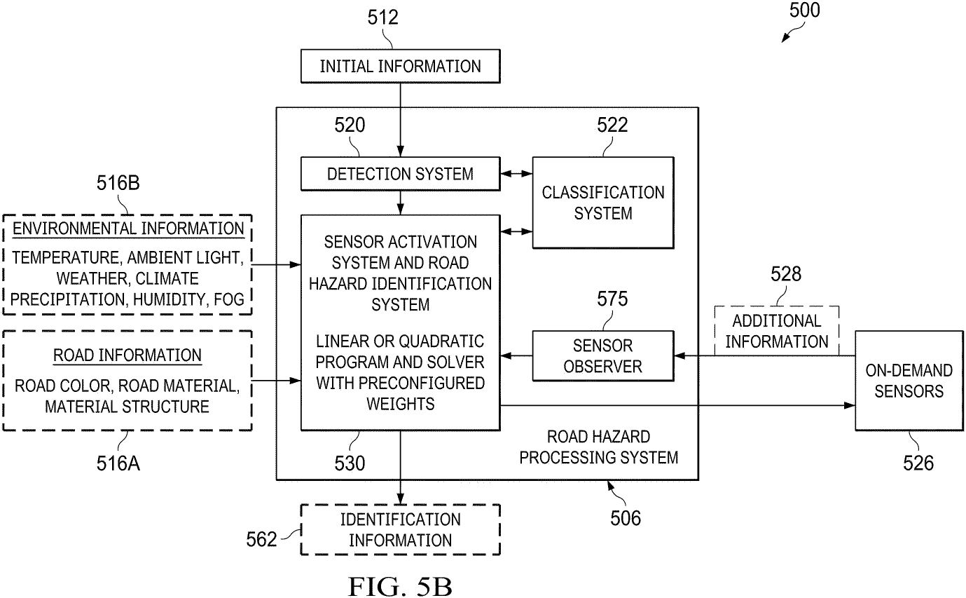

Referring now to FIGS. 5A and 5B, illustrated are diagrams of an implementation 500 of a process for motion planner constraint generation based on road surface hazards. In some embodiments, implementation 500 is performed by a road hazard constraint system 580 of a vehicle 502. In some examples, the road hazard constraint system 580 includes at least one processor for carrying out steps of the implementation. In some examples, the vehicle 502 is the same as or similar to vehicle 102 and/or vehicle 200 described above. In particular, the vehicle 502 includes a perception system 504 that is the same as or similar to the perception system 400 described above with reference to FIG. 4. In this example, the road hazard constraint system 580 is implemented by the perception system 504.

In FIG. 5A, the perception system 504 includes a road hazard processing system 506 and a constraint generation system 508. The present techniques output a motion constraint to continue navigation in the presence of the road hazard. Generally, a motion constraint is a modification or restriction on the planned motion of the vehicle. One or more always-on sensors 510 generate information 512 about a road surface ahead of the vehicle 502. As used herein “always-on” means that the sensors 510 generate information about the road surface irrespective of requests from the perception system 504. In some examples, the always-on sensors 510 include the cameras 202a, LiDAR sensors 202b, radar sensors 202c, microphones 202d, communication device 202e, autonomous vehicle computer 202f, and/or DBW system 202h as described above with reference to FIG. 2. In this way, the always-on sensors 510 can be at least one of an imaging sensor, an acoustic sensor, a temperature sensor, or an array of imaging sensors, acoustic sensors, or temperature sensors, or any combinations thereof.

In some examples, the always-on sensors 510 periodically and/or continuously generate information 512 about the road surface and transmit this information 512 to the road hazard processing system 506. In general, the always-on sensors 510 generate information 512 that includes information about one or more objects on the road surface. In some examples, the objects on the road surface are associated with a loss of traction of the road surface (e.g., ice, water, oil, sand, snow, and/or the like). In other examples, the objects are associated with obstacles (e.g., animals, construction cones, etc.) that are stationary or move over time. In some cases, these objects are identified as road hazards by the road hazard processing system 506.

In embodiments, an object is identified as a road hazard as described below. However, the term “road hazard” or “hazard” is sometimes used synonymously with the term “object.” Further details about the identification of these objects as particular road hazards using the road hazard processing system 506 is described below through various examples.

In some examples, the information 512 from the always-on sensors 510 is considered “initial” information because it is received by the road hazard processing system 506 without a request for such information and the road hazard processing system 506 can receive additional information as described below. Furthermore, the always-on sensors 510 can be considered “first” sensors because additional information is generated by additional sensors as described below.

In some embodiments, some of the always-on sensors 510 have a different sensitivity (e.g., a lower sensitivity vs. a higher sensitivity) when compared to another sensor. Generally, sensitivity refers to the responsiveness of a sensor to changes, signals, or influences. For example, if the sensors 510 are imaging sensors, an aperture of a lens of one sensor can be decreased relative to a second sensor resulting in a lower sensitivity compared to the second sensor. In this way, each of the always-on sensors 510 can be configured to have different sensitivities to cover a wider dynamic range when compared to a single always-on sensor. This can be beneficial in scenarios where the vehicle 502 identifies road hazards during daytime and during night time travels. In particular, day time and night time conditions represent opposite ends of a range of dynamic range values. The present techniques generate motion constraints to navigate a vehicle in the presence of road hazards across a wide range of dynamic range values.

In some embodiments, the initial information 512 includes a date, a time, a location, and/or spatial data generated by the always-on sensors 510. For example, in the case of an always on imaging sensor, the initial information 512 can include information 512 about the date when the image was generated, the time when the image was generated, and the latitude and longitude of the vehicle 502 when the image was generated. In some examples, the initial information includes one or more images representing a video. In some examples, the initial information 512 includes spatial pixel data of an image generated by the always-on sensors 510.

As noted above, in examples when the road surface ahead of the vehicle 500 includes a road hazard, the initial information 512 may include information about the road hazard as well. In general, the road hazard processing system 506 identifies the road hazard based on the initial information 512 and transmits such identifying information 562 to a constraint generation system 508 to generate one or more motion constraints 560 of the vehicle 502 based on the identified road hazard of the identification information 562.

In some embodiments, once the road hazard processing system 506 receives the initial information 512, the road hazard processing system 506 determines a probability that the initial information 512 (which, as noted above, might include information about one or more objects) represents at least one predetermined road hazard. In some examples, the predetermined road hazards represent a list of known road hazards. In some examples, the predetermined road hazards represent a slippery condition, as noted above. In some examples, the slippery condition is ice, water, oil, sand, and/or snow. In this way, the predetermined road hazards can represent a slippery condition of at least one of ice, water, oil, sand, and/or snow on the road surface.

Once the probability is determined and the road hazard processing system 506 determines that the probability is above a threshold (e.g., above 50%), the road hazard processing system 506 transmits a request to on-demand sensors 526 to obtain additional information about the objects that correspond to the at least one predetermined road hazard. In this way, the on-demand sensors 526 obtain information additional information about one or more objects on the road surface when the objects have a high probability of being a road hazard.

As used herein “on-demand” means that the sensors 526 generate information about the road surface in response to requests from the perception system 504. Generally, the on-demand sensors 526 generate information when requested to conserve energy, reduce overheating, reduce wear and tear, and reduce interference with the always-on sensors 510. In some examples, the on-demand sensors 526 include the cameras 202a, LiDAR sensors 202b, radar sensors 202c, microphones 202d, communication device 202e, autonomous vehicle computer 202f, and/or DBW system 202h as described above with reference to FIG. 2. In this way, the on-demand sensors 526 can be at least one of an imaging sensor, an acoustic sensor, a temperature sensor, or an array of imaging sensors, acoustic sensors, or temperature sensors, or any combinations thereof.

In some examples, the on-demand sensors 526 generate additional information 528 about the road surface and transmit this additional information 528 to the road hazard processing system 506. In this example, the information 528 is considered “additional” information because it is received by the road hazard processing system 506 in response to a request for such information and after the initial information 512 from the always-on sensors 510, as described above. In this way, the on-demand sensors 526 can be considered “second” sensors because they can be distinct from and/or used in addition to, or after, the always-on sensors 510. Additionally, like the always-on sensors 510, some of the on-demand sensors 526 can also have a different sensitivity when compared to the other on-demand sensors 526 and/or the always-on sensors 510.

Once the on-demand sensors 526 obtain the additional information about the objects, the on-demand sensors 526 transmit the additional information 528 to the road hazard processing system 506. The road hazard processing system 506 identifies a road hazard based on, at least in part, the additional information. The identification by the road hazard processing system 506 is further described with respect to FIG. 5B.

Once the road hazard processing system 506 identifies an object as at least one of the predetermined road hazards, the road hazard processing system 506 transmits the identification information 562 associated with the identified road hazard to the constraint generation system 508. In turn, the constraint generation system 508 determines one or more motion constraints 560 for the vehicle 502 based on the identification information 562. As noted above, the motion constraints 560 can include a constraint restricting the motion of the vehicle 502. In some examples, the motion constraints 560 include a particular velocity, acceleration, lane of travel, and/or steering angle variation constraint. Further details regarding the determination of the one or more motion constraints 560 is described below through various examples.

Once the constraint generation system 508 determines the one or more motion constraints 560, the constraint generation system 508 transmits the motion constraints 560 to a motion planner 550 of the vehicle 502. In turn, the motion planner 560 incorporates the motion constraints 550 into the planned path and/or trajectory of the vehicle 502 to determine control information 564 for the vehicle 502. In general, the control information 564 includes one or more input conditions for a control system 552 for to control the vehicle 502. Once the motion planner 560 determines the control information 564, the motion planner 560 transmits the control information 564 to the control system 552. In turn, the control system 552 controls control hardware of the vehicle 502 (e.g., throttle systems, steering systems, etc.) to change the path and/or trajectory of the vehicle 502. Further details regarding how the vehicle is controlled based on the motion constraints is described below through various examples.

FIG. 5B is a detailed illustration of the road hazard processing system 506 of FIG. 5A. Like items are identified by the same reference number. The road hazard processing system 506 takes as input initial information 512, additional information 528, and outputs identification information 562 associated with an identified road hazard. Referring to FIG. 5B, a detection system 520 first processes the initial information 512 before the initial information 512 is transmitted to a sensor activation system and road hazard identification system 530 for further processing (e.g., identifying the actual road hazard). If the detection system 520 determines that no objects (and therefore no road hazards) are located on the road surface, then the process terminates at the detection system 520 and instead processes the next batch of initial information generated by the always-on sensors 510 (e.g., since the always-on sensors 510 can generate information continuously). If one or more objects are detected by the detection system 520, however, then the one or more properties of the object are transmitted to the sensor activation system and road hazard identification system 530 for further analysis (e.g., to determine the probability that the object is a road hazard).

In some embodiments, the detection system 520 communicates with a classification system 522. In some examples, the classification system 522 performs an object classification analysis (e.g., via a trained neural network) to detect one or more objects within the initial information 512. In some examples, the classification system 522 is trained to detect road hazards such as ice, water, oil, sand, and/or snow on the road surface based on a previously trained neural network. In some examples, the previously trained neural network has been trained based on parameters of a surface color of road hazards and/or reflectivity of road hazards.

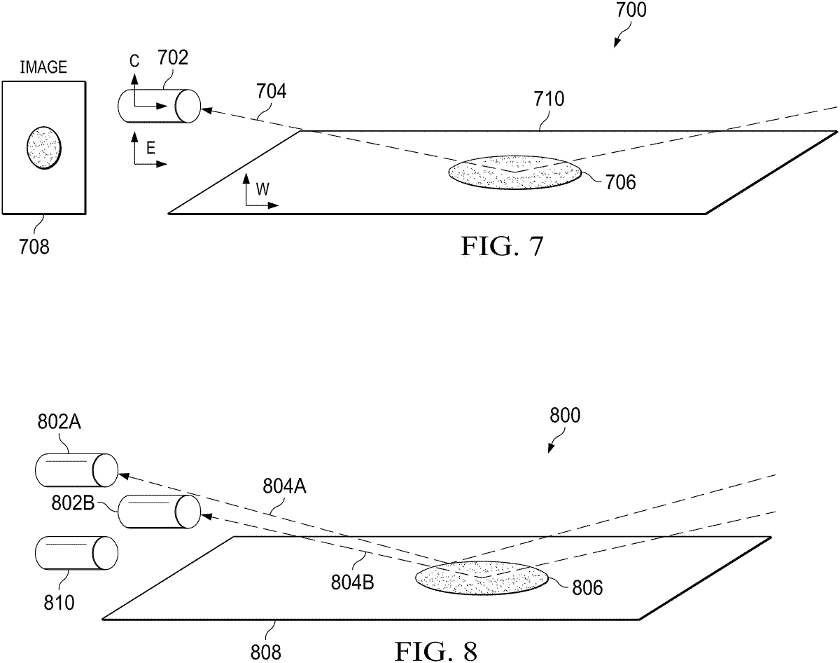

Upon identification of at least one object in the initial information 512, the initial information 512 includes information about the at least one object and is received by the sensor activation system and road hazard identification system 530. In some examples, the classification system 522 may have enough information to identify the objects as particular road hazards. In this case, identification information is also received by the by the sensor activation system and road hazard identification system 530. For example, the identification information can include information associating each detected object to a particular predetermined road hazard. In examples, the identification information includes a location and a type of the road hazard. The location is determined using a coordinate transformation as described with respect to FIG. 7.

A purpose of the sensor activation system and road hazard identification system 530 is to determine whether to activate (e.g., request information from) the on-demand sensors 526. For example, the sensor activation system and road hazard identification system 530 can determine a probability that the initial information 512 includes information about an object that represents at least one predetermined road hazard. In turn, the sensor activation system and road hazard identification system 530 can request the on-demand sensors 526 to obtain additional information about the detected object. Further details regarding how the sensor activation system and road hazard identification system 530 uses the on-demand sensors 526 is described with reference to several examples below.

The sensor observer 575 determines the health of the on-demand sensors 526. For example, the sensor observer 575 monitors sensor temperatures, time since last maintenance, and activity status to determine the reliability of the measured additional information 528 generated by the on-demand sensors 526. In some examples, the sensor observer 575 trigger alarms when maintenance or replacement of the on-demand sensors 526 is required.

Another purpose of the sensor activation system and road hazard identification system 530 is to coordinate with a classification system 552 to identify the detected object as a particular predetermined road hazard prior to transmitting identification information to the constraint generation system 508 (as shown in FIG. 5A). In the examples shown, the sensor activation system and road hazard identification system 530 receives environmental information 516B and road information 516. The sensor activation system and road hazard identification system 530 identifies the detected object as a particular predetermined road hazard based on the received environmental information 516B and road information 516. Further details regarding how the sensor activation system and road hazard identification system 530 identifies the detected object as a particular predetermined road hazard is described with reference to several examples below.

Once the sensor activation system and road hazard identification system 530 identifies the detected object as at least one of the predetermined road hazards, the sensor activation system and road hazard identification system 530 outputs identification information 562. Referring again to FIG. 5A, the identification information 562 is transmitted to the constraint generation system 508. In turn, the constraint generation system 508 outputs one or more constraints 560 to the motion planner 550. The motion planner provides motion information to the control system 552. The control system 552 provides control information to the control hardware of the vehicle 502 to cause the vehicle to move based on the one or more constraints 560.

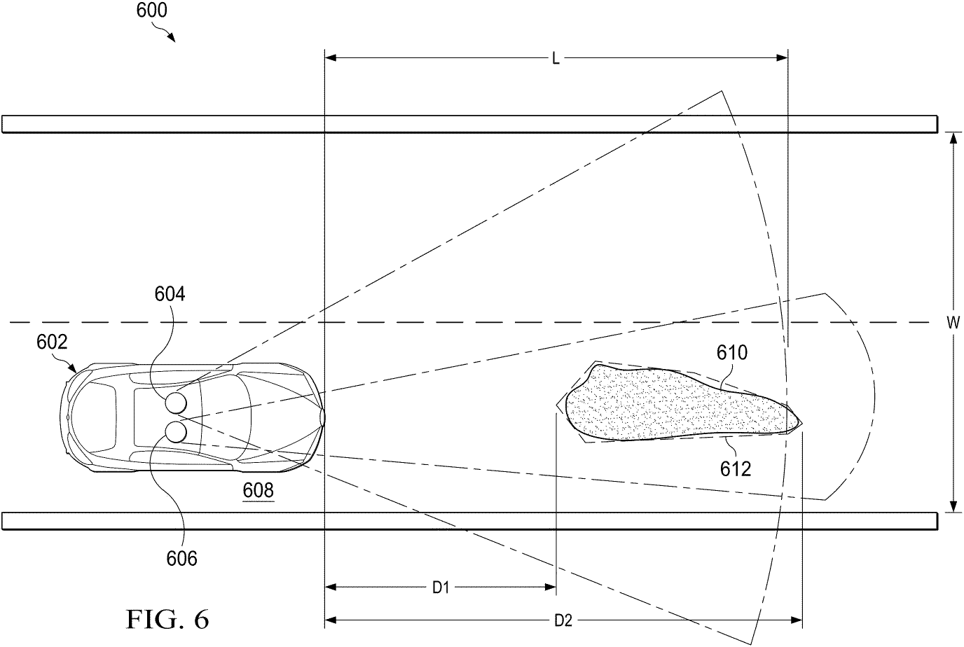

FIG. 6 shows an example vehicle 602 with an always-on sensor 604 and an on-demand sensor 606. Aspects related to on-demand sensors are described below. In some embodiments, the example vehicle 602 is the same as or similar to the vehicle 502 described above with reference to FIGS. 5A and 5B. In some embodiments, the vehicle 602 includes an implementation of a process for motion planner constraint generation based on road surface hazards that is the same as or similar to the implementation 500 described above with reference to FIGS. 5A and 5B. As a result, FIGS. 5A and 5B are referred to below.

In this example, the always-on sensor 604 is continuously generating information about an environment 600 of the vehicle 602. As noted above, the always-on sensor 604 can be a camera, a LIDAR sensor, a RADAR sensor, etc., that continuously generates information about one or more objects in the environment 600. In this example, the always-on sensor 604 has a wide-field of view that covers at least an entire width (W) of a road surface 608 in front of the vehicle 602 and a length (L) of at least one vehicle length. (Note that the figures are not necessarily to scale.) In some examples, the length (L) is between 1 and 20 vehicle lengths depending on the configuration of the always-on sensor 604 (e.g., based on the power, optics, etc. of the always-on sensor 604.)

In the example shown in FIG. 6, the road surface 608 includes an object 610 which represents a road hazard. As noted above, the road hazard can be associated with a loss of traction condition (e.g., ice, water, oil, sand, snow, a combination thereof, and/or the like) and/or physical obstacles on the road surface 608 (e.g., animals, construction cones, etc.). In this example, the road hazard is a patch of ice. The always-on sensor 604 generates initial information about the object 610 and transmits this information to the road hazard processing system 506.

FIG. 7 illustrates an example coordinate transformation. In some embodiments, the sensor activation system and road hazard identification system 530 (and/or the classification system 522 which is also in communication with sensor activation system and road hazard identification system 530 as shown in FIG. 5B) determines a location of the hazard based on a coordinate transformation. For example, the sensor activation system and road hazard identification system 530 performs a coordinate transformation from a local coordinate system of the object to a world coordinate system of the environment. Based on the transformation, the sensor activation system and road hazard identification system 530 determines the correct location of the hazard within the real world environment. In some examples, this coordinate transformation is based on one or more properties (e.g., focal length, field-of-view, etc.) of the always-on sensors 510.

In the example shown in FIG. 7, an always-on sensor 702 receives a ray of light 704 that has reflected off of a surface of an object 706 on a road surface 710 in the environment 700. Generally, the ray of light 704 represents scattered light that is not necessarily focused to a single ray (e.g., from the sun or from a light bulb). However, in some examples, the ray of light 704 can actually be a single ray of collimated light (e.g., from a laser). In this example, the initial information generated by the always-on sensor 702 is an image 708. As shown in FIG. 7, the image 708 can include a representation of the object 706.

In this example, the always-on sensor 702 is aligned with a coordinate system (C) (e.g., the axis of sensitivity of the always-on sensor 702 is collinear with one of the axes of the coordinate system (C)). A vehicle (not shown) that houses the always-on sensor 702 is aligned with a coordinate system (E) (e.g., the forward direction of the vehicle is collinear with a first axis of the coordinate system (E), the vertical direction of the vehicle is collinear with a second axis of the coordinate system (E), and the side-to-side direction of the vehicle is collinear with a third axis of the coordinate system (E)). The environment 700 is aligned with a coordinate system (W) (e.g., the longitudinal direction of Earth is collinear with a first axis of the coordinate system (W), the latitudinal direction of Earth is collinear with a second axis of the coordinate system (W), and the radially outward direction of Earth is collinear with a third axis of the coordinate system (W)).

In some embodiments, the coordinate transformation is performed by first determining the position of the always-on sensor 702 with respect to the vehicle (e.g., coordinate system (C) with respect to coordinate system (E)). Then the vehicle’s position is determined with respect to the environment (e.g., coordinate system (E) with respect to coordinate system (W)). Then the object’s 706 position is determined with respect to the always-on sensor 702 (e.g., object’s 706 position with respect to coordinate system (C)).

While only one always-on sensor 702 is shown in FIG. 7, information from multiple always-on sensors (e.g., the same or different type) can be used to calculate the locations of the objects 706 in the environment 700. For example, FIG. 8 describes a scenario with more than one always-on sensors.

FIG. 8 illustrates two always-on sensors 802A, 802B. The always-on sensors 802A, 802B are receiving rays of light 804A, 804B that have reflected off of a surface of an object 806 that represents a hazard on a road surface 808 in the environment 800. In this example, a third sensor 810 is an on-demand sensor that is described below. The scenario shown in FIG. 8 is similar to the scenario shown in FIG. 7 except that two sensors are used as the always-on sensors instead of one always-on sensor. In some examples, the sensor activation system and road hazard identification system 530 averages the generated information of one or more always-on sensors to increase the accuracy of the road hazard identification based on the initial information received by the one or more always-on sensors.

In some embodiments, the sensor activation system and road hazard identification system 530 determines one or more properties (e.g. location on the road surface, surface color, location, reflectivity, etc.) of the object 806 based on the initial information 512 and/or based on the coordinate transformations noted above.

In some embodiments, the one or more properties of the object include information about the location of the object on a road surface. For example, referring back to FIG. 6, the activation system and road hazard identification system (e.g., 530 of FIG. 5B) can determine a polygon area 612 of the object 610. In turn, the classification system 522 can determine the location of the object 610 based on the geometric center of the polygon area 612. In some examples, the location of the object 610 represents which lanes of travel the polygon area 612 spans. For example, if the polygon area 612 spans all travel lanes of the road surface 608, the activation system and road hazard identification system 530 determines that the object 610 spans all travel lanes.

In some examples, the location of the object 610 is a distance (D1) away from the vehicle 602. In some examples, the distance (D1) is defined by the space between the vehicle 602 (e.g., the front bumper or front tires of the vehicle 602) and the closest edge or vertex of the polygon area 612 of the object 610. In some examples, the location of the object 610 represents a distance (D2) away from the vehicle 602. In some examples, a distance (D2) is defined by the space between the vehicle 602 and the furthest edge or vertex of the polygon area 612 of the object 610. In some examples, both distances (D1) and (D2) are used by the constraint generation system 508 to determine one or more motion constraints of the vehicle 602 as described in detail below.

In some embodiments, the one or more properties of the object 610 include a surface color of the object 610. For example, if the sensor activation system and road hazard identification system 530 determines that the object 610 on the road surface 608 includes a white surface color, the sensor activation system and road hazard identification system 530 determines that the probability that the object 610 represents a road hazard of snow on the road surface 608 is high (e.g., above a threshold). On the other hand, if the object 610 on the road surface 608 does not include a white surface color, the sensor activation system and road hazard identification system 530 determines that the probability that the object 610 represents a road hazard of snow is low (e.g., below a threshold).

In some examples, the sensor activation system and road hazard identification system 530 determines such a threshold value based on received data (e.g., based on the received environmental information 516B and road information 516). For example, if the sensor activation system and road hazard identification system 530 determines that the probability of a white patch on the road being a snow deposit is higher than the determined threshold, then the sensor activation system and road hazard identification system 530 transmits a request to on-demand sensors 526 to obtain additional information about the white patch on the road. In some examples, the sensor activation system and road hazard identification system 530 determines the threshold values based on one or more properties of the road information 516A. For example, the one or more properties can include information about the road surface around the vehicle 502 (e.g., the road conditions, the weather, etc.).

In some embodiments, the one or more properties of the object 610 include a reflectivity of the object 610. For example, if the sensor activation system and road hazard identification system 530 determines that the object 610 on the road surface 608 has a high reflectivity (e.g., above a threshold), the sensor activation system and road hazard identification system 530 determines that the probability that the object 610 represents a road hazard of ice on the road surface 608 is high. On the other hand, if the object 610 on the road surface 608 has a low reflectivity (e.g., below a threshold), the sensor activation system and road hazard identification system 530 determines that the probability that the object 610 represents a road hazard of ice on the road surface 608 is low.

In some embodiments, having more than one always-on sensor 604 increases the information generated about the object 610. For example, the sensor activation system and road hazard identification system 530 can determine an average color and/or reflectivity of the object 610 when more than one always-on sensor 604 is used. For example, the scenario shown in FIG. 8 illustrates two always-on sensors 802A, 802B receiving rays of light 804A, 804B, respectively. The information generated by the two always-on sensors 802A, 802B is averaged by sensor activation system and road hazard identification system 530 as noted above.

In some embodiments, the sensor activation system and road hazard identification system 530 determines the probability that the object is a road hazard based on information received about the environment of the vehicle 502 and/or based on information received about the road surface around the vehicle 502.

For example, referring back to FIGS. 5A and 5B, the road hazard processing system 506, and more specifically, the sensor activation system and road hazard identification system 530 can receive information 516A, 516B from internal and/or external databases 514 (e.g. via a communication interface similar to the communication interface 314 described above with reference to FIG. 3). In some examples, the road hazard processing system 506 receives the information 516A, 516B from a database internal to the vehicle 502 (e.g., from memory). In some examples, the road hazard processing system 506 receives the information 516A, 516B from a database external to the vehicle 502 (e.g., from a remote server).

In some embodiments, the environmental information 516B can include information about the environment of the vehicle 502. In some examples, the environmental information 516B represents information about the temperature of the environment, the ambient light (e.g., dark outside vs. light outside), the weather, and/or the climate of the environment around the vehicle 502.

For example, if the road hazard processing system 506 receives information that it is currently snowing at the location of the vehicle 502, the sensor activation system and road hazard identification system 530 can determine that there is a high probability that an object in the initial information represents a road hazard representing a region of snow on the road surface.

In another example, if the road hazard processing system 506 receives information that it recently rained (e.g., within the previous 12 hours) and it is currently below freezing (e.g., below 32° F.) at the current location of the vehicle 502, the sensor activation system and road hazard identification system 530 determines that there is a high probability that an object in the initial information 512 represents a road hazard representing a region of ice on the road surface.

In yet another example, if the road hazard processing system 506 receives information that it is sandy at the location of the vehicle 502 (e.g., because the vehicle 502 is in a desert based on the location of the vehicle 502), the sensor activation system and road hazard identification system 530 determines that there is a high probability that an object in the initial information 512 represents a road hazard representing a region of sand on the road surface.

In some examples, the environmental information 516B includes information about precipitation, humidity, and fog. In some examples, the environmental information 516B includes predicted information (e.g., from a model, e.g., a weather model) and/or measured information (e.g., from one or more temperature sensors).

In some embodiments, the road information 516A includes one or more properties about the road surface around the vehicle 502. For example, the properties can include a color of the road surface (e.g., black, gray, etc.), a road material of the road surface (e.g., asphalt, concrete, dirt, brick, stone, etc.), a temperature of the road surface, a material structure of the road surface (e.g., patterned structure of bricks and stone, etc.), a slope (or grade) of the road surface (e.g., 7° downhill slope), a support of the road (e.g., whether the road surface is on a ground or on a bridge), and/or a number of crossings on the road surface (e.g., pedestrian and/or animal crossings). For example, if the one or more properties include information that the road support is a bridge, then the sensor activation system and road hazard identification system 530 can associate this road support information with a higher probability of a black ice road hazard being present and in turn can determine that the probability that the detected object representing a road hazard of ice is high.

As another example, if the one or more properties include information that a slope of the road surface is greater than 5°, then the sensor activation system and road hazard identification system 530 can associate this road support information with a higher probability of a hazardous conditions being present and in turn can determine that the probability that the detected object representing a road hazard of ice is high and activate (e.g., turn-on) the on-demand sensors 526. In some examples, the sensor activation system and road hazard identification system 530 makes this determination even after determining a lower probability of ice based on the always-on sensors 510.

While the above example illustrates the road information 516A being received from a database 514, in some embodiments, the road information 516A is determined based on the initial information. In this case, the classification system 522 processes the initial information (e.g., using the image classification approach described above) to determine the one or more properties about the road surface around the vehicle 502. In some embodiments, both approaches as used, where some road information 516A is received from a database 514 and some road information 516A is determined based on the initial information.

As noted above, the sensor activation system and road hazard identification system 530 determines the probability that the object is one of the predetermined road hazards based on the information received from the classification system, the information generated by the always-on sensors, and/or the information received about the environment and/or the road surface.

Upon determining that the probability that the object represents at least one of the predetermined road hazards is above a threshold (e.g., above 50%, above 75%, etc.), the sensor activation system and road hazard identification system 530 transmits a request for additional information about the object, as described above with reference to FIGS. 5A and 5B.

Referring back to FIG. 6, in some examples, the on-demand sensors 606 have a field of view that is narrower than the always-on sensors 604. In some examples, the on-demand sensors 606 include a field of view that is longer than the always-on sensors 604. Generally, the spatial resolution of the on-demand sensors 606 is greater than the always-on sensors 604 so that higher resolution details of the hazard 610 can be determined from the information generated by the on-demand sensors 606. For example, referring to FIG. 5B, once the request 524 is received by the on-demand sensors 526, the on-demand sensors 526 generate additional information 528 about the object 610 on the road surface 608 and transmit the additional information 528 to the sensor activation system and road hazard identification system 530.

In some embodiments, the sensor activation system and road hazard identification system 530 determines to use an emitter to generate light in the environment of the vehicle 502 to illuminate the object 610. For example, the sensor activation system and road hazard identification system 530 receives information about the ambient lighting of the environment around the vehicle 502 as described above with reference to the environmental information 516B and illustrated in FIGS. 5A and 5B. In turn, the sensor activation system and road hazard identification system 530 uses an emitter to emit energy when the ambient lighting of the environment is below a threshold (e.g., it is dark outside) and determine not to use the emitter when the ambient lighting of the environment is above a threshold (e.g., it is bright outside).

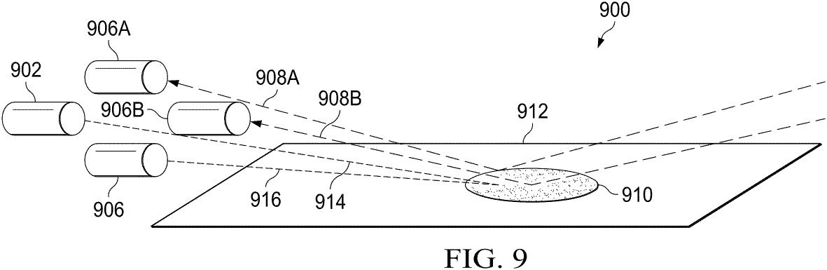

FIG. 9 illustrates an example of using an emitter 902 in association with an on-demand sensor 904. FIG. 9 shows two always-on sensors 906A, 906B receiving rays of light 908A, 908B that has reflected off of a surface of an object 910 on a road surface 912 in the environment 900. FIG. 9 is similar to FIG. 8 except that the operation of the emitter 902 in association with the on-demand sensor 904 is now illustrated.

In some embodiments, the emitter 902 is configured to provide a source of energy 914 to the environment 900. In some examples, the energy 914 is in the form of electromagnetic energy. For example, the emitter 902 can provide a source of light (e.g., visible and/or non-visible) when configured as a laser or a light bulb (e.g., a LED, etc.). In some examples, the emitter 902 provides a source of non-visible infrared light. In other examples, the emitter 902 provides a source of energy 914 in the form of sound when configured as a speaker. Reflected energy 916 then travels to the on-demand sensor 906 and is received by the on-demand sensor 906.

In some embodiments, the sensor activation system and road hazard identification system 530 determines an intensity of the source of energy 914 based on ambient light information of the environmental information 516B. For example, if the ambient light information includes information that the ambient light is below a threshold (e.g., it is dark outside), then the sensor activation system and road hazard identification system 530 decreases the intensity of the source of energy 914 to conserve power. In contrast, if the ambient light information includes information that the ambient light is above the threshold (e.g., it is bright outside), then the sensor activation system and road hazard identification system 530 increases the intensity of the source of energy 914 to increase the visibility of the object 910.

In some embodiments, the emitter 902 is configured to project a light pattern onto the road surface 912. In some examples, the emitter 902 uses at least one light source (e.g., lasers) to project the light pattern onto the road surface 912. In turn, a portion of the reflected light pattern is received by the on-demand sensor 906.

Once the on-demand sensor 906 receives reflected energy 916 (and/or the reflected light pattern) the sensor activation system and road hazard identification system 530 generates additional information 528 about the object 910 using the reflected energy 916 and the additional information is transmitted to the sensor activation system and road hazard identification system 530.

In some embodiments, the sensor activation system and road hazard identification system 530 identifies an object as a particular road hazard based on the additional information 528. In some examples, the additional information 528 will include the same or similar information as the initial information 512, except that the additional information 528 will be of higher resolution and accuracy than the initial information 512.

In some embodiments, the sensor activation system and road hazard identification system 530 determines one or more properties of an object based on the additional information. In general, the same or similar properties that were described above with reference to the sensor activation system and road hazard identification system 530 can be determined again using the additional information 528 instead of the initial information 512. For example, the one or more properties of the object can include a polygon area enclosing the object, a location of the object on the road surface, a reflectivity of the object, a surface color of the object, and/or a brightness of the object.

In some embodiments, at least some road information 516A is determined based on the additional information 528. As with the above example where some road information 516A is determined based on the initial information, the classification system 522 processes the additional information 528 (e.g., using the image classification approach described above) to determine the one or more properties about the road surface of the vehicle 502. In some embodiments, both approaches as used, where some road information 516A is received from a database 514 and some road information 516A is determined based on the initial information 512 and/or the additional information 528.

In some embodiments, the sensor activation system and road hazard identification system 530 identifies the object as a particular road hazard using a linear or quadratic solver with preconfigured weights. In some examples, the preconfigured weights are assembled based on multiple outputs from multiple sensors. In some examples, the preconfigured weights are tuned by a user based on measured information and/or are learned by a computer using a machine learning algorithm.

The above discussion describes a proactive determination of road hazards. In some embodiments, a reactive determination of the road hazard can also be performed by the road hazard processing system 506. For example, the road hazard processing system 506 can receive vehicle control information (e.g., from a controller of the vehicle 502 or an inertial measurement unit of the vehicle 502) to determine if the vehicle 502 has lost traction (e.g., when one or more wheels of the vehicle are slipping relative to the road surface) and determine one or more road hazards present on the road surface based on the vehicle control information.

In some examples, the road hazard processing system 506 receives inertial information generated by an inertial measurement unit of the vehicle 502 directly. In this case, the inertial information represents vehicle dynamics of the vehicle 502. The road hazard processing system 506 determine an inertial difference between the vehicle dynamics of the vehicle 502 and a prediction of vehicle dynamics generated by the motion planner of the vehicle 502. In this way, the probability that the initial information and/or the additional information about the object represents the at least one predetermined road hazard is based on the inertial difference.

For example, if the road hazard processing system 506 determines that the vehicle 502 has lost traction, then the road hazard processing system 506 determines a high probability that the object is a road hazard and the vehicle 502 is currently travelling on the road hazard.

Referring back to FIG. 5A, the constraint generation system 508 determines one or more motion constraints 560 of the vehicle 502 based on the identification information 562 about the identified road hazard.

In some embodiments, the constraint generation system 508 determines the one or more motion constraints 560 to include a steering angle constraint. For example, if the road hazard processing system 506 determines that the object represents a road hazard ahead in the current lane of travel of the vehicle 502, the constraint generation system 508 can determine a motion constraint 560 to steer around the perimeter of the road hazard.

As noted above, in some examples, the road hazard processing system 506 determines the perimeter of the object representing the road hazard based on a polygon area. For example, referring again to FIG. 6, the polygon area 612 defines the perimeter of the object 610. Once the polygon area 612 is determined, then the constraint generation system 508 can determine a motion constraint 560 to steer around the perimeter of the road hazard based on the polygon area 612 of the object 610. In some examples, the polygon area includes information about distances (D1) and (D2) as shown in FIG. 6. In such cases, the constraint generation system 508 can determine a motion constraint 560 to steer around the perimeter of the road hazard based on a space between the vehicle 602 and the closest edge or vertex of the polygon area 612 of the object 610 and/or a space between the vehicle 602 and the furthest edge or vertex of the polygon area 612 of the object 610.

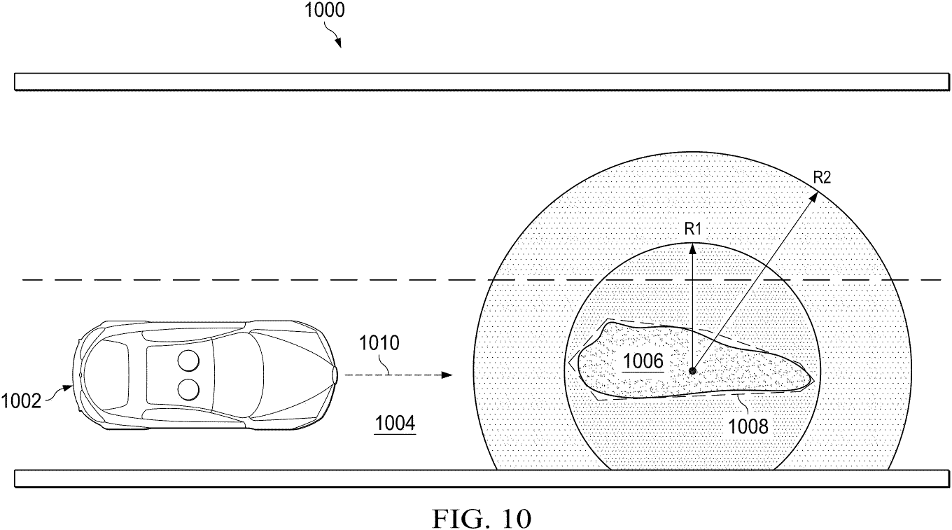

FIG. 10 shows a similar scenario to FIG. 6. In the example shown in FIG. 10, a vehicle 1002 is driving along on a road surface 1004 that includes an object 1006 that represents a road hazard. In some embodiments, the vehicle 1002 is the same as or similar to the vehicle 602 described above with reference to FIG. 6. In some embodiments, the vehicle 1102 includes an implementation of a process for motion planner constraint generation based on road surface hazards that is the same as or similar to the implementation 500 described above with reference to FIGS. 5A and 5B. As a result, FIGS. 5A and 5B are referred to below.

FIG. 10 illustrates a scenario where the road hazard processing system 506 identifies an object 1006 as at least one road hazard 1006 and determines a polygon area 1008 encompassing the object 1006. In some examples, the object 1006 is identified as at least one of the predetermined road hazards as noted above. In turn, the constraint generation system 508 determines one or more constraints 560 for the vehicle.

In some embodiments, the constraint generation system 508 determines the motion constraint 560 to include a first motion constraint 560 within the polygon area 1008 of the object 1006 and a second motion constraint 560 outside the polygonal area 1008 of the object 1006. In some examples, the first motion constraint 560 is a first velocity constraint (e.g., requiring the vehicle 1002 to maintain a velocity that does not exceed the first velocity constraint) and the second motion constraint 560 is a second velocity constraint (e.g., requiring the vehicle 1002 to maintain a velocity that does not exceed the second velocity constraint). For example, the first motion constraint 560 can be a velocity constraint of 10 MPH within the polygon area 1008 and the second motion constraint 560 can be a different velocity constraint of 20 MPH outside the polygon area 1008.

In some embodiments, the constraint generation system 508 determines the motion constraint 560 to include a motion constraint that is based on a radial distance from the polygon area 1008 of the object 1006. In some examples, the motion constraint 560 represents a velocity gradient between a first velocity limit and a second velocity limit based on a distance from the polygonal area 1008 of the object 1006.

For example, the motion constraint 560 can be a constant velocity constraint of 10 MPH within the polygon area 1008 that decreases (e.g., linearly, exponentially, etc.) as a function of a radial distance from the polygon area 1006. In this example, the motion constraint 560 represents a constraint that decreases linearly as a function of the radial distance from the geometric center of the polygon area 1008 from a first velocity constraint (e.g., 5 MPH) to a second velocity constraint (e.g., 10 MPH) at distance (R1) outside the polygon area 1008 and to a third velocity constraint (e.g., 15 MPH) at distance (R2) outside the polygon area 1008.

While the illustration of FIG. 10 represents a motion constraint 560 that decreases as a function of the radial distance from the geometric center of the polygon area 1006, other motion constraints are possible. For example, a motion constraint 560 can decrease (linearly, exponentially, etc.) as a function of a distance from one or more edges or vertices of the polygon area 1008.

While above discussion describes a motion constraint 560 that includes three discrete velocity constraints, it is possible to include a continuously varying velocity constraint as a function of the radial distance. Furthermore, while specific velocities were used in this example (e.g., 5 MPH, 10 MPH, 15 MPH), other velocities are possible (e.g., any velocity between 0-100 MPH).

While the above discussion describes a motion constraint 560 that includes one or more velocity constraints, other motion constraints are possible. For example, some motion constraints 560 include at least one of an acceleration constraint (e.g., to limit the vehicle’s acceleration to be below a threshold (e.g., 1 g, 2 g, etc.)), a distance constraint (e.g., to limit the distance between the vehicle and another vehicle on the road surface, and/or a prohibited travel lane constraint (e.g., to restrict the vehicle from travelling on a particular lane of the road surface).

In some embodiments, the motion constraint 560 includes a constraint associated with the polygon area of the road hazard. In some examples, the motion constraint 560 includes a constraint to minimize vehicle acceleration changes, vehicle jerk, velocity changes, and/or steering angle changes while traveling on the road hazard. For example, it can be dangerous to perform lane changes and/or accelerate on slippery hazards.

In some embodiments, the specific velocities used in the velocity constraint are based on the specific road hazard determined. For example, referring to the illustration of FIG. 10, if the road hazard processing system 506 identifies the object 1006 as a road hazard representing ice, the constraint generation system 508 can determine motion constraints 560 that have a set of velocities (e.g., a first velocity constraint of 5 MPH within the polygon area 1008, a second velocity constraint of 10 MPH outside the polygon area 1008 but within the distance (R1), and a third velocity constraint of 15 MPH outside of the distance (R1) but within the distance (R2)). On the other hand, if the road hazard processing system 506 identifies the object 1006 as a road hazard representing sand, the constraint generation system 508 can determine motion constraints 560 that have a different set of velocities (e.g., a first velocity constraint of 10 MPH within the polygon area 1008, a second velocity constraint of 15 MPH outside the polygon area 1008 but within the distance (R1), and a third velocity constraint of 20 MPH outside of the distance (R1) but within the distance (R2)).

Referring back to FIG. 5A, the constraint generation system 508 can receive vehicle information 518 about the vehicle 502 and use this vehicle information 518 to determine the one or more motion constraints 560. In some examples, the vehicle information 518 represents information about a vehicle capability. In some examples, the vehicle information 518 can be received from the same internal and/or external databases 514 described above with reference to the road hazard processing system 506. In some examples, the constraint generation system 508 receives the vehicle information 518 from one or more components of the vehicle 502 directly (e.g., directly from a controller of the vehicle, a braking system, etc.).

The constraint generation system 508 uses this vehicle information 518 to determine what motion constraints 560 to apply when particular road hazards are identified. For example, if the vehicle 502 is an off-road vehicle (e.g., because the vehicle information 518 includes information that the vehicle 502 has a four-wheel drive capability) then the constraint generation system 508 can generate a motion constraint 560 to travel over an identified road hazard of snow at a slow speed. On the other hand, if the vehicle 502 is not an off-road vehicle (e.g., because the vehicle information 518 includes information that the vehicle 502 does not have a four-wheel drive capability) then the constraint generation system 508 can generate a motion constraint 560 to avoid (e.g., steer around) the identified road hazard of snow.

In some examples, the vehicle information 518 represents at least one of a drive wheel configuration of the vehicle 502, a tire pressure level of a tire of the vehicle 502, a tire type of a tire of the vehicle 502 (e.g., summer tires, winter tires, etc.), or whether the vehicle 502 is an off-road vehicle. In some cases, the vehicle information 518 represents whether the vehicle 502 is a two-wheel-drive vehicle or a four-wheel-drive vehicle. In some cases, the vehicle information 518 represents whether the vehicle 502 is a front-wheel-drive vehicle, a rear-wheel-drive vehicle, or a four-wheel-drive vehicle (sometimes referred to as an all-wheel-drive vehicle).

In some embodiments, the constraint generation system 508 determines one or more motion constraints 560 and/or drive settings of the vehicle 502 based on the vehicle information 518. For example, if the constraint generation system 508 receives information that it is snowing at the location of the vehicle 502 and the vehicle 502 has a four-wheel-drive vehicle capability, then the constraint generation system 508 can instruct a vehicle controller of the vehicle 502 to switch the vehicle 502 into a four-wheel-drive mode to improve traction on the snow. In another example, if the constraint generation system 508 receives information that the tire pressure is low (e.g., below 20 psi) in one or more tires of the vehicle 502, then the constraint generation system 508 can instruct a vehicle controller of the vehicle 502 to proceed more cautiously (e.g., slow down, use four-wheel-drive). In another example, if the constraint generation system 508 receives information that the tire type of one or more tires of the vehicle 502 represents summer tires (e.g., by performing a table lookup of makes/models of tires), then the constraint generation system 508 can instruct a vehicle controller of the vehicle 502 to do proceed more cautiously (e.g., slow down, use four-wheel-drive, minimize steering angle changes, etc.).

In some embodiments, the constraint generation system 508 determines one or more motion constraints 560 based on one or more properties of the road surface. As noted above, the road hazard processing system 506 can receive road information 516A and this information 516A can be transmitted to the constraint generation system 508. In addition to the road information 516A described above, the road information 516A can also include information about one or more crossings (e.g., pedestrian and/or animal crossings.) For example, if a crossing is ahead, then the constraint generation system 508 determines a motion constraint 560 that causes the vehicle 502 to slow down (and in some examples, stop) to avoid a loss of control scenario through the crossing. For example, the constraint generation system 508 determines a motion constraint 560 that requires the vehicle 502 to proceed cautiously (e.g., slow down, minimize steering angle changes, etc.).

In some embodiments, the constraint generation system 508 determines one or more motion constraints 560 based on a slope of the road surface (based on the one or more properties of the road surface). For example, if the slope is greater (e.g., steeper) than a threshold (e.g., greater than a 5° downhill grade), then the constraint generation system 508 determines a motion constraint 560 that causes the vehicle 502 to stop or at least slow down to reduce a loss of traction situation.

In another example, the constraint generation system 508 determines one or more motion constraints 560 based on a material of the road surface (based on the one or more properties of the road surface). For example, if the material is asphalt, then the constraint generation system 508 determines a motion constraint 560 that causes the vehicle 502 to avoid steering changes to reduce the likelihood that the vehicle 502 loses control on the asphalt.

In some embodiments, the constraint generation system 508 assigns a priority to each motion constraint 560. For example, a high priority can represent motion constraints 560 that need to be imposed at (nearly) all costs while a low priority can represent a motion constraint 560 that does not need to be imposed. In some examples, the constraint generation system 508 determines the priority to be assigned based a level of risk of harm to passengers and/or pedestrians.

Referring back to FIG. 5A, once the constraint generation system 508 determines all the motion constraints 560 for the particular road hazard, the constraint generation system 508 outputs all the motion constraints 560 to a motion planner 550 of the vehicle 502. In turn, the motion planner 500 determines a movement 582 of the vehicle 502 on the road surface based on all the motion constraints 560.

In some embodiments, the motion planner 550 prioritizes the motion constraints 560. For example, the motion planner 550 can prioritize each motion constraint 560 of the at least one motion constraints 560. In some examples, the motion planner 550 prioritizes the motion constraints 560 based on one or more factors (e.g., vehicle route, rules of the road, other vehicles in the environment 1000, passenger comfort, etc.). For example, the motion planner 550 can receive information that a crossing (e.g., a pedestrian and/or animal crossing) is ahead and/or that animal crossings are common in the environment of the vehicle 502.

Once the motion planner 550 prioritizes the motion constraints 560, the motion planner 550 applies the motion constraints 560 to determine a movement 582 of the vehicle 502 that satisfies as many motion constraints 560 as possible. In some examples, not all motion constraints 560 will be applied because of conflicting motion constraints 560 and/or the one or more factors. In this way, prioritizing the motion constraints 560 can be important.

In some embodiments, the motion planner 550 determines the movement 582 to include a steering angle constraint and/or a velocity constraint. For example, as illustrated in FIG. 10, the motion planner 550 determines a movement 582 representing a path 1010 straight through an object 1008 that has been identified as a road hazard. For example, the motion planner 550 can determine the path 1010 as the best movement 582 that satisfies as many motion constraints 560 as possible. In some examples, travelling through the road hazard is feasible when the neighboring lane is blocked or when it is dangerous to stop the vehicle 1002 (e.g., because of traffic behind the vehicle 1002 and/or the vehicle 1002 is located in a violent area (e.g., within a radius of a prison), etc.). In this example, the motion planner 550 determines the movement 582 to include a steering angle constraint that restricts the vehicle 502 to the same lane it is currently travelling.

In the example of FIG. 10, the motion constraints 560 includes a velocity constraint that varies linearly with the radially distance from the geometric center of the polygon area 1008 of the object 1006 representing the road hazard. As described above, the motion constraint 560 represents a constraint that decreases from a first velocity constraint (e.g., 5 MPH) within the polygon region 1008 to a second velocity constraint (e.g., 10 MPH) at distance (R1) outside the polygon area 1008 to a third velocity constraint (e.g., 15 MPH) at distance (R2) outside the polygon area 1008. In this way, when the vehicle 1002 is controlled to drive along the path 1010 (as described in further detail below), the vehicle 1002 will slow down to no more than 15 MPH within the third region at the radial distance of (R2), then slow down to no more than 10 MPH within the second region at the radial distance of (R1), then slow down to no more than 5 MPH within the polygon area 1008. In this way, the vehicle 1002 gradually slows down to travel safely through the road hazard 1006.

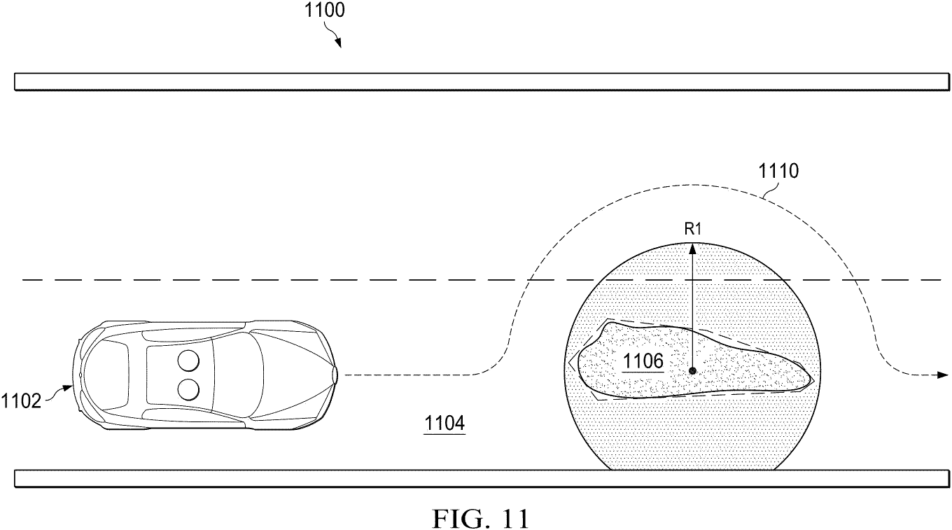

FIG. 11 illustrates an example of a movement 582 that includes a steering angle variation. FIG. 11 shows a vehicle 1102 travelling on a road surface 1104 within an environment 1100. In some embodiments, the vehicle 1102 is the same as or similar to any of the above described vehicles (e.g., vehicle 502). In some embodiments, the vehicle 1102 includes an implementation of a process for motion planner constraint generation based on road surface hazards that is the same as or similar to the implementation 500 described above with reference to FIGS. 5A and 5B. As a result, FIGS. 5A and 5B are referred to below.

The scenario shown in FIG. 11 is similar to the scenario shown in FIG. 10. However, in FIG. 11, the motion planner 550 of the vehicle 1102 determines a movement 582 that includes a path 1110 around an object 1106 that represents a road hazard. In this example, the constraint generation system 508 determines a motion constraint 560 where the vehicle 1102 shall not pass through the road hazard. Furthermore, the constraint generation system 508 determines a velocity constraint within the region (R1). In turn, the motion planner 550 determines a movement 582 that does not pass through the road hazard and preferably avoids the region (R1). In this scenario, the motion constraint 560 associated with avoiding the road hazard is assigned a high priority by the constraint generation system 508 and as a result, the motion planner 550 determines the movement 582 to include the path 1110 around the road hazard.

Referring back to FIG. 5A, once the motion planner 550 determines the movement 582, the motion planner 550 transmits the movement 582 (e.g., information about the movement 582) to a control system 552. In turn, the control system 552 generates control information 564 associated with controlling the vehicle 502 based on the movement 582 which is based on the at least one motion constraint 560. In some examples, the control information 564 represents control information for a drive train of the vehicle 502 and/or a steering assembly of the vehicle 502. In some examples, the control system 552 generates control information 564 using one or more PID controllers.

Once the control system 552 determines the control information 564, the control system 552 transmits the control information 564 to the respective controlled hardware to cause the vehicle 502 to operate based on the movement 582. For example, the control system 552 transmits the control information 564 to a control system 552 of the drive train and/or the steering assembly of the vehicle 502. Generally, the drive train includes a throttle response controller to control the acceleration and deceleration of the vehicle 502 and the control information 564 is operable to cause the vehicle 502 to accelerate and decelerate via the drive train. Furthermore, generally, the steering assembly includes a steering controller to control the steering angle of the vehicle 502 and the control information 564 is operable to cause the vehicle 502 to vary the steering angle via the steering assembly.

Referring back to FIG. 10, the steering controller and the throttle response controller cause the vehicle the vehicle 1002 to drive through the object 1008 that has been identified as a road hazard. In the example illustrated in FIG. 11, the steering controller and the throttle response controller causes the vehicle 1102 to drive around the road hazard 1106. In some examples, the motion constraints 560 include both a steering angle constraint and a velocity constraint.

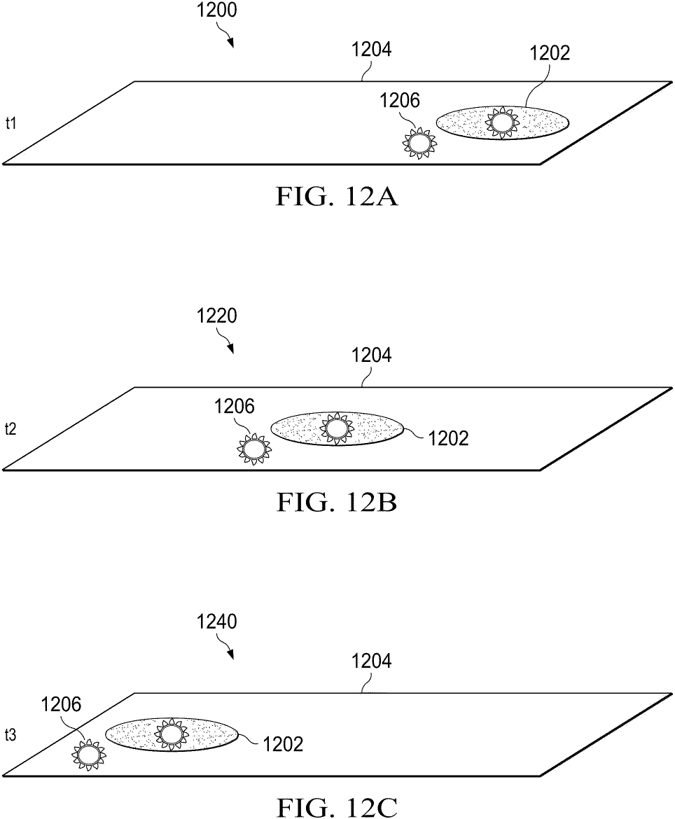

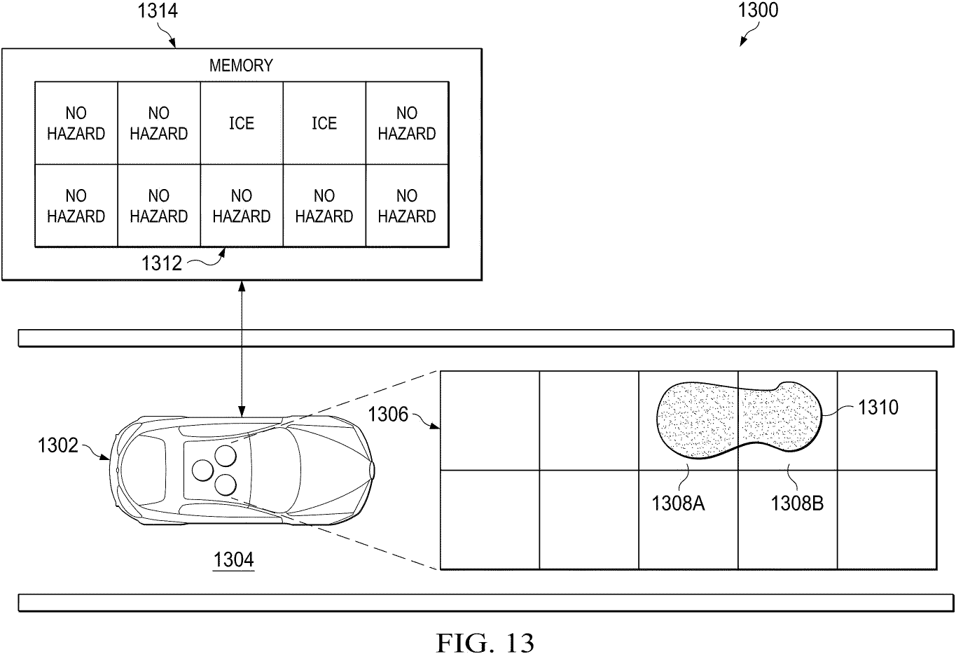

FIGS. 12A-12C illustrate a temporal variation of road hazards. For example, FIG. 12A shows an object 1202 representing a road hazard on a road surface 1204. The object 1202 is illuminated by ambient light 1206 (e.g., generated by the sun). In turn, the sensors of vehicle (not shown in FIGS. 12A-12C) receive the reflected ambient light and generate information representing the object 1202.

As a vehicle travels on the road surface 1204 (not shown in FIGS. 12A-12C), the amount of reflected light can vary. For example, such a phenomenon is common when the object 1202 represents a very reflective road hazard such as ice. In these cases it can be difficult to identify the road hazard based on a single instance of information generated by the sensors. One approach to resolve this issue is to continuously determine one or more properties of the road hazard as the vehicle is moving through the environment and combine (e.g., average) the results. This results in different perspective views of the object 1202 to improve the road hazard identification.

For example, the road hazard constraint system 580 can determines one or more properties of the object 1202 at one or more positions along the road surface 1204. For example, in the example shown in FIGS. 12A-12C, a vehicle (not shown) travels from the left-hand side of the figure to the right-hand-side of the figure. The objects 1202 shown in FIGS. 12A-12C represent the relative position of a road hazard on the road surface 1204 to the vehicle as a function of time. In this way, FIG. 12A represents a scenario 1200 where the road hazard is furthest from the vehicle, FIG. 12C represents a scenario 1240 where the road hazard is closest to the vehicle, and FIG. 12B represents a scenario 1220 where the road hazard is about midway between the positions shown in FIGS. 12A and 12C. In this way, one or more properties of an object are continuously determined as the vehicle is traveling towards the object. In some examples, the properties include the reflectivity, as noted above.

In some embodiments, the road hazard constraint system 580 identifies the object 1202 as a particular road hazard based on the one or more properties of the object 1202 at one or more positons along the road surface 1204. For example, the road hazard constraint system 580 can average the results and/or use information that properly identifies the road hazard while discarding the other information.

FIG. 13 illustrates a vehicle 1302 travelling on a road surface 1304 within an environment 1300. In some embodiments, the vehicle 1302 is the same as or similar to any of the above described vehicles (e.g., vehicle 502). In some embodiments, the vehicle 1302 includes an implementation of a process for motion planner constraint generation based on road surface hazards that is the same as or similar to the implementation 500 described above with reference to FIGS. 5A and 5B.

In some embodiments, the road hazard constraint system 580 partitions a digital representation of road surface 1304 into one or more regions. For example, the road hazard constraint system 580 partitions the road surface 1304 into one or more regions along the width direction of the road surface 1304 (e.g., perpendicular to the vehicle’s forward travel direction) and one or more regions along the longitudinal direction of the road surface 1304 (e.g., along the vehicle’s forward travel direction). In the example shown, the road hazard constraint system 580 partitions the road surface 1304 into two regions along the width direction and five regions along the longitudinal direction.

In some embodiments, the road hazard constraint system 580 partitions the digital representation of road surface 1304 into equally-sized regions 1306. For example, FIG. 13 shows equal-sized regions 1306. In this example, each region 1306 has the same width and length dimensions. However, in other embodiments, the road hazard constraint system 580 partitions the digital representation of road surface 1304 into randomly-sized regions.

In some embodiments, the road hazard constraint system 580 determines whether one or more road hazards have been identified within each region 1306 of the one or more regions (e.g., based on the processes described above with reference to the road hazard processing system 506). In some examples, the road hazard constraint system 580 loops over each identified road hazard to determine if the road hazard exists within the boundaries for each region 1306. If the road hazard constraint system 580 determines that a road hazard is present within a particular region, then the road hazard constraint system 580 assigns the particular road hazard to that particular region.

For example, as shown in FIG. 13, the road hazard constraint system 580 identifies an object 1310 as a particular road hazard via the process described above with reference to FIGS. 5A and 5B. In this example, the object 1310 has been identified as a road hazard representing ice (e.g., based on the reflectivity of a surface of the object 1310 and environmental information 516B, etc.). The road hazard constraint system 580 determines that the road hazard representing ice spans two regions 1306 (regions 1308A and 1308B). The road hazard constraint system 580 also determines that all the other regions 1306 do not include a road hazard (e.g., because the always-on sensors 510 and/or the on-demand sensors 526 have not detected any objects in those particular regions 1306).

In some embodiments, the road hazard constraint system 580 stores road hazard information 1312 associated with each region in memory 1314. In some examples, memory 1314 is on-board memory. In other examples, the memory 1314 is remote memory (e.g., cloud-based memory). In some embodiments, the memory 1314 is hosted by a remote server external to the vehicle 1302 and accessible from other vehicles.

In this example, the road hazard constraint system 580 transmits the road hazard information 1312 to the memory 1314. In general, the road hazard information 1312 includes information about one or more of the regions 1306 and whether or not a road hazard has been identified within each of the regions 1306. In some examples, the particular road hazard is also included in this information. In the example shown in FIG. 13, the road hazard information 1312 includes information about ten regions 1306.

In some embodiments, the road hazard constraint system 580 merges the road hazard information 1312 associated with each region in memory 1314 with historical road hazard information. For example, the road hazard constraint system 580 can merge the road hazard information 1312 with historical information to build a map of road hazards for an entire city or town. In some examples, the remote server updates the regions 1306 of the map when new road hazard information 1312 is received from one or more vehicles driving within the environment 1300.

In some embodiments, the road hazard constraint system 580 retrieves road hazard information 1312 of an environment 1300 of the vehicle 1302 from the memory 1314. For example, the road hazard constraint system 580 can retrieve (e.g., download) road hazard information 1312 for path planning purposes (e.g., to avoid particular roads).

In some embodiments, the road hazard constraint system 580 determines one or more motion constraints 560 based on the historical road hazard information. For example, the road hazard constraint system 580 can determine a motion constraint 560 representing a constraint to avoid particular roads in an environment 1300 based on road that historically have road hazards present. In turn, the motion planner of the vehicle 1302 can determine the movement 582 of the vehicle 1302 based on these motion constraints 560.

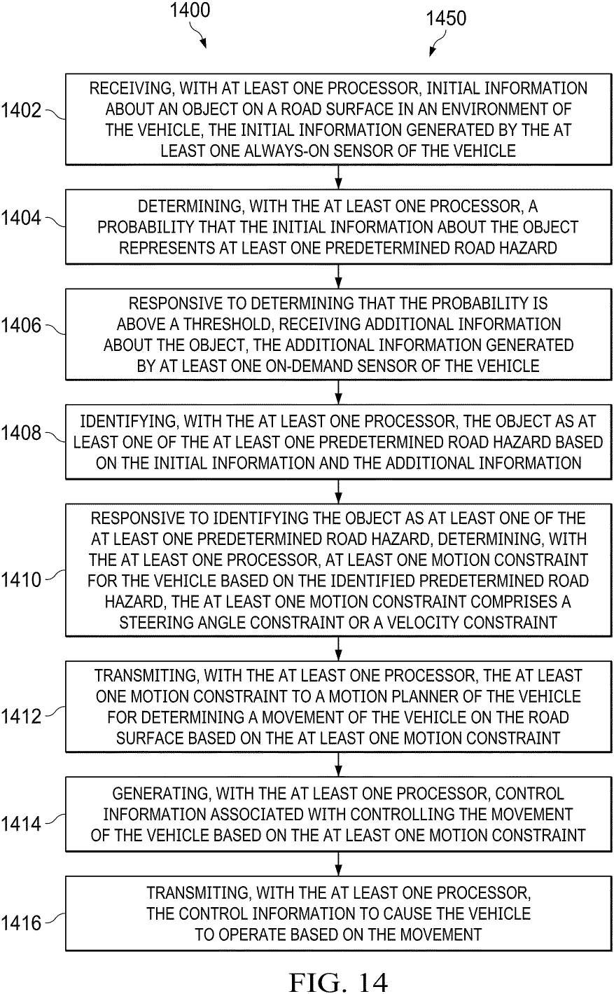

Referring now to FIG. 14, illustrated is a flowchart of a process 1400 for motion planner constraint generation based on road surface hazards. In some embodiments, one or more of the steps described with respect to process 1400 are performed (e.g., completely, partially, and/or the like) by a road hazard constraint system 1450. In some embodiments, the road hazard constraint system 1450 is the same as or similar to the road hazard constraint system 580 described with reference to FIGS. 5A and 5B.

In some embodiments, the road hazard constraint system 1420 includes at least one always-on sensor, at least one on-demand sensor, at least one processor, and at least one non-transitory storage media storing instructions that, when executed by the at least one processor, cause the at least one processor to perform one or more steps of the process 1400.

In some examples, the road hazard constraint system 1450 is implemented within a vehicle and in other examples the road hazard constraint system 1450 is implemented external to a vehicle (e.g., by a remote server). Additionally, or alternatively, in some embodiments one or more steps described with respect to process 1400 are performed (e.g., completely, partially, and/or the like) across multiple vehicles having road hazard constraint systems in a distributed manner.

With continued reference to FIG. 14, the road hazard constraint system 1450 receives, with the at least one processor, initial information about an object on a road surface in an environment of the vehicle, the initial information generated by the at least one always-on sensor of the vehicle (block 1402). For example, as described above with reference to FIG. 6, the always-on sensors 604 of the vehicle 602 generate initial information about an object 610 in the environment 600. In turn, the road hazard processing system 506 of the road hazard constraint system 580 receives the initial information from the always-on sensors 604.

With continued reference to FIG. 14, the road hazard constraint system 1450 determines, with the at least one processor, a probability that the initial information about the object represents at least one predetermined road hazard (block 1404). For example, as shown in FIG. 5A, the level 1 detection system 520 of the road hazard constraint system 580 and the sensor activation system and road hazard identification system 530 of the road hazard constraint system 580 both determine probabilities that the initial information about the object represents at least one predetermined road hazard.

With continued reference to FIG. 14, responsive to determining that the probability is above a threshold, the road hazard constraint system 1450 receives, with the at least one processor, additional information about the object, the additional information generated by the at least one on-demand sensor of the vehicle (block 1406). For example, as described above with reference to FIG. 6, the on-demand sensors 606 of the vehicle 602 generate additional information about the object 610 in the environment 600. In turn, the road hazard processing system 506 of the road hazard constraint system 580 receives the additional information from the on-demand sensors 606.

With continued reference to FIG. 14, the road hazard constraint system 1450 identifies, with the at least one processor, the object as at least one of the at least one predetermined road hazard based on the initial information and the additional information (block 1408). For example, as described above with reference to FIG. 5B, the sensor activation system and road hazard identification system 530 of the road hazard constraint system 580, identifies an object as at least one of the at least one predetermined road hazard.

With continued reference to FIG. 14, responsive to identifying the object as at least one of the at least one predetermined road hazard, the road hazard constraint system 1450 determines, with the at least one processor, at least one motion constraint for the vehicle based on the identified predetermined road hazard, the at least one motion constraint comprises a steering angle constraint or a velocity constraint (block 1410). For example, as described with reference to FIG. 5A, the constraint generation system 508 of the road hazard constraint system 580 determines at least motion constraint 560 for the vehicle 502. In the examples described with reference to FIGS. 10 and 11, the at least one motion constraint 560 includes a steering angle constraint and/or a velocity constraint.

With continued reference to FIG. 14, the road hazard constraint system 1450 transmits, with the at least one processor, the at least one motion constraint to a motion planner of the vehicle for determining a movement of the vehicle on the road surface based on the at least one motion constraint (block 1412). For example, as described with reference to FIG. 5A, the constraint generation system 508 of the road hazard constraint system 580 transmits the at least one motion constraint 560 to the motion planner 550 of the road hazard constraint system 580.

With continued reference to FIG. 14, the road hazard constraint system 1450 generates, with the at least one processor, control information associated with controlling the movement of the vehicle based on the at least one motion constraint (block 1414). For example, as described with reference to FIG. 5A, the control system 552 of the road hazard constraint system 580 generates control information associated with controlling the movement 582 of the vehicle 502 based on the at least one motion constraint 560.

With continued reference to FIG. 14, the road hazard constraint system 1450 transmits, with the at least one processor, the control information to cause the vehicle to operate based on the movement (block 1416). For example, as described with reference to FIG. 5A, the control system 552 of the road hazard constraint system 580 transmits the control information to cause the vehicle 502 to operate based on the movement 582.

While the above examples describe scenarios with a single road hazard, it is possible to use the systems and methods described herein to identify multiple road hazards. In some examples, the road hazard processing system 506 identifies more than one road hazard and transmits information for all of these road hazards to the constraint generation system 508. In turn, the constraint generation system 508 determines one or more motion constraints 560 based on each of the identified road hazards. In turn, the motion planner can prioritize all of these motion constraints 560 as described above to minimize the level risk to passengers and/or pedestrians.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A vehicle comprising:
at least one always-on sensor and at least one on-demand sensor;
at least one processor, and
at least one non-transitory storage media storing instructions that, when executed by the at least one processor, cause the at least one processor to:
receive initial information about an object on a road surface in an environment of the vehicle, the initial information generated by the at least one always-on sensor of the vehicle;
determine a probability that the initial information about the object represents at least one predetermined road hazard;
responsive to determining that the probability is above a threshold, receive additional information about the object, the additional information generated by the at least one on-demand sensor of the vehicle;
identify the object as at least one of the at least one predetermined road hazard based on the initial information and the additional information;
responsive to identifying the object as at least one of the at least one predetermined road hazard, determine at least one motion constraint for the vehicle based on the identified predetermined road hazard, the at least one motion constraint comprising a steering angle constraint or a velocity constraint;
transmit the at least one motion constraint to a motion planner of the vehicle for determining a movement of the vehicle on the road surface based on the at least one motion constraint;
generate control information associated with controlling the movement of the vehicle based on the at least one motion constraint; and
transmit the control information to cause the vehicle to operate based on the movement.

2. The vehicle of claim 1, wherein the at least one predetermined road hazard comprises ice, water, oil, sand, snow, or a combination thereof, and each of the at least one predetermined road hazard is associated with a loss of traction.

3. The vehicle of claim 1, wherein the at least one always-on sensor is at least one of an imaging sensor, an acoustic sensor, a temperature sensor, or an array of imaging sensors, acoustic sensors, or temperature sensors,
wherein the at least one always-on sensor is configured to generate data about the environment of the vehicle continuously.

4. The vehicle of claim 1, wherein the at least one on-demand sensor is at least one of an imaging sensor, an acoustic sensor, a temperature sensor, or an array of imaging sensors, acoustic sensors, or temperature sensors,
wherein the at least one on-demand sensor is configured to generate data about the environment of the vehicle when a request is received.

5. The vehicle of claim 1, wherein the at least one non-transitory storage media storing instructions that, when executed by the at least one processor, cause the at least one processor to:
determine one or more properties of the object based on the initial information generated by the at least one always-on sensor or the additional information generated by the at least one on-demand sensor, the one or more properties of the object comprising a location of the object on the road surface and a reflectivity of the object,
wherein identifying the object as at least one of the at least one predetermined road hazard is further based on the one or more properties of the object.

6. The vehicle of claim 1, wherein the at least one non-transitory storage media storing instructions that, when executed by the at least one processor, cause the at least one processor to:
determine one or more properties of the object based on the initial information generated by the at least one always-on sensor or the additional information generated by the at least one on-demand sensor, the one or more properties of the object comprising a polygon area enclosing the object,
wherein determining the at least one motion constraint is further based on the one or more properties of the object.

7. The vehicle of claim 1, wherein the at least one non-transitory storage media storing instructions that, when executed by the at least one processor, cause the at least one processor to:
responsive to determining that the probability is above a threshold, transmit a request to the at least one on-demand sensor to generate the additional information about the object,
wherein the at least one on-demand sensor does not generate the additional information about the object unless the request is received by the at least one on-demand sensor.

8. The vehicle of claim 1, wherein the probability that the initial information about the object represents the at least one predetermined road hazard is based on a location of the vehicle within the environment and an ambient temperature of the environment.

9. The vehicle of claim 1, wherein the at least one non-transitory storage media storing instructions that, when executed by the at least one processor, cause the at least one processor to:
receive inertial information generated by an inertial measurement unit of the vehicle, the inertial information representing vehicle dynamics of the vehicle; and
determine an inertial difference between the vehicle dynamics of the vehicle and a prediction of vehicle dynamics generated by a motion planner of the vehicle,
wherein the probability that the initial information about the object represents the at least one predetermined road hazard is based on the inertial difference.

10. The vehicle of claim 1, wherein the at least one non-transitory storage media storing instructions that, when executed by the at least one processor, cause the at least one processor to:
receive a road surface property of the road surface, the road surface property of comprising at least one of a slope of the road surface or a material of the road surface,
wherein determining the motion constraint is further based on the road surface property.

11. The vehicle of claim 1, wherein the at least one non-transitory storage media storing instructions that, when executed by the at least one processor, cause the at least one processor to:
receive vehicle information about a capability of vehicle, the vehicle information comprising a drive wheel configuration of the vehicle, the drive wheel configuration representing whether the vehicle is a two-wheel-drive vehicle or a four-wheel-drive vehicle;
wherein determining the motion constraint is further based on the vehicle information.

12. The vehicle of claim 11, wherein the drive wheel configuration further represents whether the vehicle is a front-wheel-drive vehicle, a rear-wheel-drive vehicle, or an all-wheel-drive vehicle.

13. The vehicle of claim 1, further comprising:
a drive train of the vehicle; and
a steering assembly of the vehicle;
wherein the at least one non-transitory storage media storing instructions that, when executed by the at least one processor, cause the at least one processor to:
control, with the drive train of the vehicle and the steering assembly of the vehicle, the vehicle based on the at least one motion constraint.

14. The vehicle of claim 1, wherein the motion constraint comprises both the steering angle constraint and the velocity constraint.

15. The vehicle of claim 1, wherein the at least one motion constraint comprises at least one of an acceleration constraint, a distance between the vehicle and another vehicle on the road surface, or a prohibited line of travel on the road surface.

16. The vehicle of claim 1, wherein the at least one motion constraint comprises:
a first velocity limit inside a polygonal area of the road hazard,
a second velocity limit outside the polygonal area of the road hazard, and
a velocity gradient between the first velocity limit and the second velocity limit based on a distance from the polygonal area of the road hazard.

17. IGNORE.

18. IGNORE.

19. The vehicle of claim 1, wherein the at least one non-transitory storage media storing instructions that, when executed by the at least one processor, cause the at least one processor to:
prioritize each motion constraint of the at least one motion constraints,
wherein generating the control information associated with controlling the movement of the vehicle is further based on the prioritized motion constraints.

20. A method comprising:
receiving, with at least one processor, initial information about an object on a road surface in an environment of a vehicle generated by an at least one always-on sensor of the vehicle;
determining, with the at least one processor, a probability that the initial information about the object represents at least one predetermined road hazard;
responsive to determining that the probability is above a threshold, receiving, with the at least one processor, additional information about the object, the additional information generated by at least one on-demand sensor of the vehicle;
identifying, with the at least one processor, the object as at least one of the at least one predetermined road hazard based on the initial information and the additional information;
responsive to identifying the object as at least one of the at least one predetermined road hazard, determining, with the at least one processor, at least one motion constraint for the vehicle based on the identified predetermined road hazard, the at least one motion constraint comprising a steering angle constraint or a velocity constraint;
transmitting, with the at least one processor, the at least one motion constraint to a motion planner of the vehicle for determining a movement of the vehicle on the road surface based on the at least one motion constraint;
generating, with the at least one processor, control information associated with controlling the movement of the vehicle based on the at least one motion constraint; and
transmitting, with the at least one processor, the control information to cause the vehicle to operate based on the movement.

21. The method of claim 20, wherein the at least one predetermined road hazard comprises ice, water, oil, sand, snow, or a combination thereof and each of the at least one predetermined road hazard is associated with a loss of traction.

22. The method of claim 20 , further comprising:
continuously acquiring, with the at least one always-on sensor, initial information about objects in the environment; and
acquiring, with the at least one on-demand sensor, additional information about objects in the environment only when a request is received.

23. The method of claim 20, further comprising:
controlling, with a drive train of the vehicle and a steering assembly of the vehicle, the vehicle based on the at least one motion constraint.

24. The method of claim 20, wherein the motion constraint comprises both the steering angle constraint and the velocity constraint.

25. The method of claim 20, wherein the at least one motion constraint comprises:
a first velocity limit inside a polygonal area of the road hazard,
a second velocity limit outside the polygonal area of the road hazard, and
a velocity gradient between the first velocity limit and the second velocity limit based on a distance from the polygonal area of the road hazard.

26. The method of claim 20, further comprising:
responsive to determining that the probability is above a threshold, receiving additional information about the object,
emitting, with a least one light source, a light onto the road surface; and
receiving, with the at least one on-demand sensor, a reflected portion of the light;
wherein identifying the object as at least one of the at least one predetermined road hazard is further based on information associated with the reflected portion of the light.

27. A non-transitory computer-readable storage medium comprising at least one program for execution by at least one processor, the at least one program including instructions which, when executed by the at least one processor, cause a vehicle to perform the computer-implemented method of:
receiving initial information about an object on a road surface in an environment of the vehicle generated by an at least one always-on sensor of the vehicle;
determining a probability that the initial information about the object represents at least one predetermined road hazard;
responsive to determining that the probability is above a threshold, receiving additional information about the object, the additional information generated by at least one on-demand sensor of the vehicle;
identifying the object as at least one of the at least one predetermined road hazard based on the initial information and the additional information;
responsive to identifying the object as at least one of the at least one predetermined road hazard, determining at least one motion constraint for the vehicle based on the identified predetermined road hazard, the at least one motion constraint comprising a steering angle constraint or a velocity constraint;
transmitting the at least one motion constraint to a motion planner of the vehicle for determining a movement of the vehicle on the road surface based on the at least one motion constraint;
generating control information associated with controlling the movement of the vehicle based on the at least one motion constraint; and
transmitting the control information to cause the vehicle to operate based on the movement.
